(19) United States
(12) Patent Application Publication
(10) Pub. No.: US 2014/0120371 A1
(43) Pub. Date: May 1, 2014

(54) COLD-ROLLED STEEL PLATE COATED WITH ZINC OR A ZINC ALLOY, METHOD FOR MANUFACTURING SAME, AND USE OF SUCH A STEEL PLATE

(71) Applicants: Papa Amadou Mactar Mbacke, Paris (FR); Antoine Moulin, Metz (FR)

(72) Inventors: Papa Amadou Mactar Mbacke, Paris (FR); Antoine Moulin, Metz (FR)

(73) Assignee: ARCELORMITTAL INVESTIGACION Y DESARROLLO SL, Sestao Bizkaia (ES)

(21) Appl. No.: 14/124,940

(22) PCT Filed: May 17, 2012
(86) PCT No.: PCT/FR2012/000150

§ 371 Date: Dec. 27, 2013

(30) Foreign Application Priority Data
Jun. 7, 2011 (FR) PCT/FR2011/000331

(51) Int. Cl. C23C 2/02; B23K 11/11; B32B 15/01

(52) U.S. Cl. CPC C23C 2/02; B32B 15/013; B23K 11/11
USPC 428/659; 148/522; 219/86.1

(57) ABSTRACT

The present invention provides a “TRIP effect” cold-rolled and annealed steel sheet which has improved formability and weldability, strength between 780 and 900 MPa and elongation at fracture greater than 19%, the composition of which includes the following elements in percentages expressed by weight: 0.17%≦C≦0.25%, 1.5%≦Mn≦2%, 0.50%≦Si≦1%, 0.50%≦Al≦1.2%, whereby Si+Al≧1.30%, the remainder of the composition including iron and the inevitable impurities resulting from processing. The microstructure of the sheet includes 65 to 85% ferrite and 15 to 35% islands of martensite and residual austenite. The average size of these islands of martensite and residual austenite is less than 1.3 micrometers and their shape factor is less than 3.

This invention relates to the fabrication of coated, cold-rolled sheets that exhibit a “TRIP” (Transformation Induced Plasticity) effect for the fabrication of parts by forming and are intended in particular for use in motor vehicles.

### BACKGROUND

The reduction of greenhouse gas emissions in the field of motor vehicle design is currently a challenge which is being tackled by reductions in the weight of the vehicles and in turn a reduction in their fuel consumption. When that challenge is combined with the safety imperatives of new-generation vehicles, the automakers have been forced to make increasing use of steels with increased mechanical strength in the body of the vehicle to reduce the thickness of the parts and thus the weight of the vehicles. Nevertheless, parts for new-generation vehicles have complex shapes and the steel sheets from which they are fabricated must have sufficient ductility.

Under these conditions, TRIP steels have experienced major growth because they combine high strength with high formability.

This good compromise between mechanical strength and formability is the result of TRIP steel's complex structure including ferrite, which is a ductile component, harder components such as islands of martensite and austenite (MA), the majority of which consists of residual austenite, and finally the bainitic ferrite matrix which has a mechanical strength and ductility which are intermediate between ferrite and the MA islands. TRIP steels have a very high capacity for consolidation, which makes possible a good distribution of the deformations in the case of a collision or even during the forming of the automobile part. It is therefore possible to fabricate parts which are as complex as those made of conventional steels but with improved mechanical properties, which in turn makes it possible to reduce the thickness of the parts to comply with identical functional specifications in terms of mechanical performance. These steels are therefore an effective response to the requirements of reduced weight and increased safety in vehicles. In the field of hot-rolled or cold-rolled steel sheet, this type of steel has applications for, among other things, structural and safety parts for automotive vehicles.

Recent requirements to reduce vehicle weight and energy consumption have led to a demand for certain TRIP steels, the mechanical strength Rm of which is between 780 and 900 MPa, with a total elongation greater than 19% with an ISO-type test piece. In addition to this level of strength and ductility, these steels must have good weldability and a high degree of suitability for continuous hot-dip galvanizing. These steels must also exhibit a high degree of bendability.

In this regard, the prior art document JP2001254138 describes steels that have the following chemical composition: 0.05-0.3% C, 0.3-2.5% Si, 0.5-3.0% Mn and 0.001-2.0% Al, the remainder consisting of iron and the inevitable impurities. The structure contains residual austenite in which the mass concentration of carbon is greater than or equal to 1% and the volume fraction is between 3 and 50%, as well as ferrite, the form factor of which is between 0.5 and 3 and the volume of which is between 50 and 97%. This prior art document refers to an uncoated steel, and in the framework of this patent the invention cannot be used to form a steel that requires a particular mechanical strength associated with high ductility to form a complex, coated structural part for an automotive vehicle.

The prior art document WO2002101112 also describes steels that have the following chemical composition: C: 0.0001-0.3%, Si: 0.001 to 2.5%, Mn: 0.001-3%, Al: 0.0001-4%, P: 0.0001-0.3%, S: 0.0001-0.1% and optionally one or more of the following elements: Nb, Ti, V, Zr, Hf and Ta in total between 0.001 and 1%, B: 0.0001 to 0.1%, Mo: 0.001 to 5%, Cr: 0.001 to 25%, Ni: 0.001 to 10%, Cu: 0.001 to 5%, Co: 0.001 to 5%, W: 0.001 to 5%, and Y, REM, Ca, Mg and Ce in total between 0.0001 and 1%, the remainder consisting of iron and the inevitable impurities. The claimed microstructure consists of 50 to 97% ferrite or ferrite+bainite combined as the principal structure and austenite as the second phase, with a content between 3 and 50% in total volume. The teaching of this document does not make it possible to form a sheet that requires a particular mechanical strength associated with high degree of ductility to form a complex coated part intended for use in an automobile structure.

### SUMMARY OF THE INVENTION

An object of the present invention is to provide a steel sheet coated with Zn or a Zn alloy with a combination of the criteria of improved formability, coatability and weldability. A low sensitivity to embrittlement by liquid zinc during penetration of the zinc during welding improves the behavior of the coated and welded part in service. This embrittlement is explained by a melting of the base coat of zinc or zinc alloy due to the high temperatures to which it is exposed during welding. At these temperatures, the liquid Zn penetrates into the austenitic grain boundaries of the steel and causes embrittlement, which leads to a premature appearance of cracks in the zones exposed to high external stresses during spot welding, for example.

In this sense, an object of the present invention provides “TRIP effect” steel sheets that have a mechanical strength between 780 and 900 MPa together with an elongation at fracture greater than 19%. This sheet must be coatable with Zn or Zn alloy and must be relatively insensitive to the penetration of Zn in the austenitic grain boundaries.

An additional object of the present invention is to make available an economical fabrication method by eliminating the need for the addition of expensive alloy elements.

The sheet can be fabricated using any suitable fabrication method. However, it is advantageous to use a fabrication method in which small variations of the parameters do not result in significant modifications of the microstructure or of the mechanical properties.

One particularly advantageous object of the invention is to make available a steel sheet which is easily cold-rolled, i.e. one whose hardness after the hot-rolling step is limited so that the rolling forces required during the cold-rolling step remain moderate.

The present invention provides a cold-rolled, annealed steel sheet coated with zinc or a zinc alloy, the composition of which is as follows, whereby the contents are expressed in percent by weight:

0.17%≦C≦0.25%

1.5%≦Mn≦2.0%

0.50%≦Si≦1%

0.50%≦Al≦1.2%

B≦0.001%

P≦0.030%

S≦0.01%

Nb≦0.030%

Ti≦0.020%

V≦0.015%

Cu≦0.1%

Cr≦0.150%

Ni≦0.1%

0%≦Mo≦0.150%

whereby Si+Al≧1.30%,

the remainder of the composition consisting of iron and the inevitable impurities resulting from processing, the microstructure consisting, with the contents expressed in area percentage, of 65 to 85% ferrite, 15 to 35% islands of martensite and residual austenite, said ferrite containing less than 5% non-recrystallized ferrite, it being understood that the total residual austenite content is between 10 and 25% and the total martensite content is less than or equal to 10%, the average size of said martensite and residual austenite islands is less than 1.3 micrometers, their average shape factor is less than 3, the mechanical strength Rm is between 780 and 900 MPa and the elongation at fracture A % is greater than or equal to 19%.

The present invention may also exhibit the characteristics listed below, considered individually or in combination:
the composition includes, expressed in percent by weight:

0.19%≦C≦0.23%
the composition includes, expressed in percent by weight:

1.6%≦Mn≦1.8%
the composition includes, expressed in percent by weight:

0.7%≦Si≦0.9%
the composition includes, expressed in percent by weight:

0.6%≦Al≦0.8%
the composition includes, expressed in percent by weight:

0%<B≦0.0005%,
more than 90% in area percentage of the islands of martensite and residual austenite are of a size less than or equal to two micrometers.

An additional object of the present invention is a fabrication method for a cold rolled, annealed sheet coated with zinc or zinc alloy consisting of the steps listed below:
A steel having the composition claimed by the invention is obtained, then
This steel is cast in the form of a semi-finished product, then
This semi-finished product is heated to a temperature between 1150 and 1250° C., then
This semi-finished product is hot rolled, finishing the rolling at an end-of-rolling temperature T_{FL} which is greater than or equal to Ar3 to obtain a sheet, then
This hot rolled sheet is coiled at a temperature T_{bob} between 500 and 600° C., then
This hot-rolled sheet is cooled to the ambient temperature, then,
If necessary, this hot rolled sheet is pickled, then
This sheet is cold-rolled, then
This cold-rolled sheet is then reheated at a rate V_{c} between 1 and 30° C./s to a temperature Tᵣ for a length of time tᵣ which is greater than or equal to 15 seconds, said temperatures and times being selected to obtain an area percentage of between 35 and 70% austenite, with the remainder consisting of polygonal ferrite, then
This cold-rolled sheet is cooled to a temperature T_{eg} between 475 and 440° C. at a rate V_{ref} which is sufficiently rapid to prevent the formation of pearlite, then
The cold-rolled sheet is held at the equalization temperature T_{eg} for a length of time t_{eg} between 20 and 120 seconds, then
The cold-rolled sheet is coated by continuous hot-dipping in a bath of zinc or zinc alloy, then
The cold-rolled, coated sheet is cooled to the ambient temperature.

The present invention may also exhibit the characteristics listed below, considered individually or in combination:

the end-of-rolling temperature T_{FL} is greater than 900° C.

the end-of-rolling temperature T_{FL} is equal or greater than 920° C.

the dew point during the annealing at Tᵣ for the length of time tᵣ is between −20° C. and −15° C.

the annealing temperature Tr is between Ac1+50° C. and Ac3−50° C.

the annealing temperature Tr is between Ac1+50° C. and Ac1+170° C.

the time t_{eg} is preferably between 30 and 80 seconds.

the time t_{eg} is ideally between 30 and 60 seconds.

The sheet claimed by the present invention may be suitable for spot resistance welding.

An additional object of the present invention is the use of a cold-rolled, annealed and coated sheet claimed by the invention or obtained by a method claimed by the invention for the fabrication of structural or safety parts for ground motor vehicles.

### BRIEF DESCRIPTION OF THE DRAWINGS

Additional characteristics and advantages of the invention are presented in the following description, which is given purely by way of example and makes reference to the accompanying figures, in which:

FIG. 1 shows the dimensions of the tensile test piece used to measure the mechanical properties, whereby the numerical dimensions are presented in Table 4.

FIG. 2 presents an example of the microstructure of a steel sheet according to the present invention with the MA islands in white and the matrix that contains the polygonal ferrite and bainite in black.

FIG. 3 presents an example of the distribution of the shape factors of the MA islands according to the present invention as a function of the respective maximum length.

### DETAILED DESCRIPTION

Also within the framework of the present invention, the influence of the fraction of austenite formed during the inter-critical hold and its combination with the equalization temperature on the final mechanical behavior of the steel sheet has been brought to light.

Carbon plays a significant role in the formation of the microstructure and in the mechanical properties in terms of ductility and strength via the TRIP effect: the mechanical strength becomes insufficient below 0.17% carbon by weight. Above 0.25%, the weldability is progressively reduced, although the TRIP effect is improved. The carbon content is advantageously between 0.19 and 0.23% inclusive.

Manganese is an element that provides hardening by substitutional solid solution, which increases hardenability and slows down the precipitation of carbides. A minimum content of 1.5% by weight is necessary to obtain the desired mechanical properties. Nevertheless, above 2% its gammagenic character results in the formation of an excessively banded structure, which can adversely affect the forming properties of the automotive structural part, and the coatability of the steel is reduced. The manganese content is advantageously between 1.6 and 1.8% inclusive.

The stabilization of the residual austenite is made possible by the addition of silicon and aluminum, which significantly slow down the precipitation of carbides during the annealing cycle, and most particularly during the bainitic transformation. That makes possible the enrichment of the austenite with carbon, leading to its stabilization at the ambient temperature in the coated steel sheet. The subsequent application of an outside stress, during forming, for example, will lead to the transformation of this austenite into martensite. This transformation results in a good compromise between the mechanical strength and ductility of TRIP steels.

Silicon is an element which hardens in substitutional solid solution. This element also plays an important role in the formation of the microstructure by slowing down the precipitation of carbides during the equalization step following the primary cooling, which makes it possible to concentrate the carbon in the residual austenite for its stabilization. Silicon plays an effective role combined with that of aluminum, the best results from which, with regard to the specified properties, are obtained in content levels above 0.50%. However, an addition of silicon in a quantity greater than 1% risks an adverse effect on the suitability for hot-dip coating by promoting the formation of oxides that adhere to the surface of the products; the silicon content must be limited to 1% by weight to facilitate hot-dip coatability. The silicon content will preferably be between 0.7 and 0.9% inclusive. Silicon also reduces weldability; a content less than or equal to 1% simultaneously provides very good suitability for welding as well as good coatability.

Aluminum plays an important role in the invention by greatly slowing down the precipitation of carbides; its effect is combined with that of silicon, whereby the contents of silicon and aluminum by weight are such that: Si+Al≧1.30% to sufficiently retard the precipitation of carbides and to stabilize the residual austenite. This effect is obtained when the aluminum content is greater than 0.50% and when it is less than 1.2%. The aluminum content will preferably be less than or equal to 0.8% and greater than or equal to 0.6%. It is also generally thought that high levels of Al increase the erosion of refractory materials and the risk of plugging of the nozzles during casting of the steel upstream of the rolling. Aluminum also segregates negatively and can result in macro-segregations. In excessive quantities, aluminum reduces hot ductility and increases the risk of the appearance of defects during continuous casting. Without careful control of the casting conditions, micro and macro segregation defects ultimately result in a central segregation in the annealed steel sheet. This central band will be harder than its surrounding matrix and will adversely affect the formability of the material.

Above a sulfur content of 0.01%, the ductility is reduced on account of the excessive presence of sulfides such as MnS (manganese sulfides), which reduce the workability of the steel, and is also a source for the initiation of cracks. It is also a residual element, the content of which should be limited.

Phosphorus is an element that hardens in solid solution but significantly reduces suitability for spot welding and hot ductility, in particular on account of its tendency toward grain boundary segregation or its tendency to co-segregate with manganese. For these reasons, its content must be limited to 0.03% to obtain good suitability for spot welding and good hot ductility. It is also a residual element, the content of which should be limited.

Molybdenum plays an effective role in determining hardenability and hardness and delays the appearance of bainite. However, the addition of molybdenum excessively increases the cost of the addition of alloy elements, so that for economic reasons its content is limited to 0.150% or even to 0.100%.

Chromium, as a result of its role in determining hardenability, also contributes to delaying the formation of pro-eutectoid ferrite. This element also contributes to hardening by substitutional solid solution, although for economic reasons its content is limited to 0.150%, or even to 0.100%, because it is an expensive alloy element.

Nickel, which is a powerful stabilizer of austenite, promotes the stabilization of the austenite. At levels above 0.1%, however, the cost of the addition of alloy elements makes little sense from a financial point of view. The nickel content is therefore limited to 0.1% for economic reasons.

Copper, which is also a stabilizer of austenite, promotes the stabilization of the austenite. At levels above 0.1%, however, the cost of the addition of alloy elements makes little sense from a financial point of view. The copper content is therefore limited to 0.1% for economic reasons.

Boron exerts a strong influence on the hardenability of the steel. It limits the activity of the carbon and limits the diffusional phase transformations (ferritic or bainitic transformation during cooling), thereby promoting the formation of hardening phases such as martensite. This effect is not desirable in the present invention, because the objective is to promote the bainitic transformation to stabilize the austenite and prevent the formation of an excessive area percentage of martensite. The boron content is therefore limited to 0.001%.

Micro-alloy elements such as niobium, titanium and vanadium are respectively limited to the maximum levels of 0.030%, 0.020% and 0.015%, because these elements have the particular feature of forming hardening precipitates with carbon and/or nitrogen, which also tend to reduce the ductility of the product. They also delay recrystallization during the heating and hold step of the annealing and therefore refine the microstructure, which also hardens the material.

The remainder of the composition consists of iron and the inevitable impurities resulting from processing.

TRIP effect steels have a microstructure that contains islands of residual austenite and martensite called “MA islands”, as well as ferrite. This ferrite can be subdivided into two categories: inter-critical ferrite, which is polygonal ferrite, formed during the hold after the heating as part of the annealing at Tᵣ, and bainitic ferrite, free of carbides, formed, after the hold, during the primary cooling and during the equalization step which is part of the annealing. The term “ferrite” as used below includes both sub-categories. The martensite that is present in the microstructure is undesirable, but it is difficult to eliminate entirely.

The advantageous properties of the sheet claimed by the invention are obtained thanks to the combination of a microstructure that includes polygonal ferrite, bainitic ferrite and islands of residual austenite and martensite with a particular chemical composition which is defined in the claims.

In the context of the invention, not more than 5% non-recrystallized ferrite is formed. This proportion of non-recrystallized ferrite is evaluated as follows: after having identified the ferritic phase within the microstructure, the area percentage of non-recrystallized ferrite is quantified in relation to the totality of the ferritic phase. This non-recrystallized phase has very low ductility, is the source of the initiation of cracks during shaping into the final form, and does not make it possible to achieve the characteristics specified by the invention.

The present invention teaches that the microstructure is constituted, with content levels expressed in area percentage, of 65 to 85% ferrite, 15 to 35% martensite and residual austenite islands, whereby the total content of residual austenite is between 10 and 25% and the total martensite content is less than or equal to 10% in area percentage.

A quantity of MA islands less than 15% does not allow any significant increase in the resistance to damage. Nor would the total elongation of 19% be achieved. Moreover, because the MA islands are hard, if their content level is less than 15%, there is a risk of not achieving the specified 780 MPa. Beyond 35%, a high carbon content would be required to sufficiently stabilize it, and that would adversely affect the weldability of the steel. Preferably, the carbon content by weight of the residual austenite is greater than 0.8% to obtain MA islands that are sufficiently stable at the ambient temperature. In the framework of the invention, the ferrite makes it possible to improve ductility, and the presence of this ductile structure is necessary to achieve the specified total elongation of 19%. The bainitic ferrite makes it possible to stabilize the residual austenite.

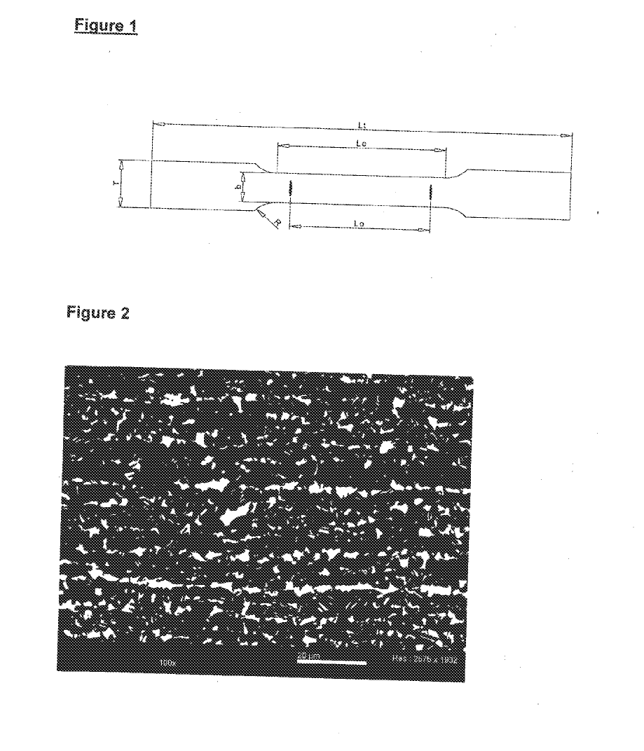

FIG. 2 illustrates a microstructure claimed by the invention with an image produced by an optical microscope. The MA islands appear in white and the ferrite is in black. At this stage, no distinction is made between polygonal ferrite and bainitic ferrite because the magnification is too low, and in both cases there is a cube-centered structure from the crystallographic point of view. The principal difference is that the bainitic ferrite has a density of dislocations and a carbon content which are higher than those of polygonal inter-critical ferrite.

For example, the method claimed by the invention can comprise the successive steps listed below.

A steel having the composition claimed by the invention is obtained, then a semi-finished product is cast from this steel. The steel can be cast into ingots, or the steel can be continuously cast in the form of slabs.

The cast semi-finished products are first brought to a temperature T_{rech} greater than 1150° C. and less than 1250° C. so that at all points it reaches a temperature favorable to the high rates of deformation the steel will undergo during rolling. This temperature range makes it possible to be in the austenitic range.

However, if the temperature T_{rech} is greater than 1275° C., the austenite grains grow undesirably large and lead to a coarser final structure.

The semi-finished product is hot rolled in a temperature range where the structure of the steel is therefore totally austenitic; if the end-of-rolling temperature T_{FL} is less than the temperature of the beginning of transformation of the austenite into ferrite during cooling Ar3, the ferrite grains are work-hardened by the rolling and the ductility is significantly reduced. Preferably, an end-of-rolling temperature T_{FL} greater than 900° C. will be selected. Even greater preference is given to an end-of-rolling temperature T_{FL} which is greater than or equal to 920° C.

The hot-rolled product is then coiled at a temperature T_{bob} between 500 and 600° C. This temperature range makes it possible to obtain a complete bainitic transformation during the quasi-isothermal hold associated with the coiling followed by a slow cooling. A coiling temperature greater than 600° C. leads to the formation of undesirable oxides.

When the coiling temperature is too low, the hardness of the product is increased, which increases the forces that must be applied during the subsequent cold rolling.

If necessary, the hot-rolled product can then be pickled using a method that is itself known, followed by a cold rolling with a reduction rate which is preferably between 30 and 80%.

The cold-rolled product is then heated, preferably in a continuous annealing installation, at an average heating rate V_{c} between 1 and 30° C./s. In relation to the annealing temperature Tᵣ below, a heating rate in this range makes it possible to obtain a non-recrystallized ferrite fraction below 5%.

The heating is performed up to an annealing temperature Tᵣ, which is preferably between the temperature Ac1 (temperature at which the allotropic transformation begins during the heating) +50° C., and Ac3 (temperature of the end of allotropic transformation during heating)-50° C., and for a length of time tᵣ selected such that between 35 and 70% inter-critical austenite is obtained. That can be achieved in particular by selecting, with an eye toward energy conservation, the temperature Tᵣ between Ac1+50° C. and Ac1+170° C. When Tᵣ is less than (Ac1+50° C.), the structure can also contain zones of non-recrystallized ferrite, the area percentage of which can reach 5%. An annealing temperature Tᵣ claimed by the present invention makes it possible to obtain a sufficient quantity of inter-critical austenite to subsequently form, during cooling, ferrite in a quantity such that the residual austenite will be sufficiently stabilized and the desired mechanical characteristics will be achieved.

When the fraction of inter-critical austenite is greater than 70%, at the temperature Tᵣ, its carbon concentration is low, which leads to a subsequent too rapid transformation and too rich in polygonal and bainitic ferrite respectively during cooling and during the equalization step between 440 and 475° C. Because ferrite is not a very hard phase, its presence in excessive quantities makes it impossible to achieve the target of 780 MPa and to have a total elongation ≧19%.

The length of the hold t_{rec} is between 15 and 300 seconds. A minimum hold time tᵣ greater than or equal to 15 seconds at the temperature Tᵣ allows the dissolution of the carbides, and above all a sufficient transformation to austenite. The effect is saturated beyond a time of 300 s. A hold time greater than 300 seconds is also difficult to reconcile with the production requirements of continuous annealing installations, in particular the unwinding speed of the coil.

At the end of the annealing hold, the sheet is cooled to a temperature which is close to the temperature T_{eg}, the cooling rate V_{ref} being sufficiently rapid to prevent any transformation during cooling and in particular the formation of pearlite, which absorbs carbon. For this purpose, the cooling rate V_{ref} is preferably greater than 5° C./s. At this stage, a partial transformation of the austenite into ferrite occurs. This makes it possible, when the C is expelled toward the austenite, because the latter is relatively insoluble in ferrite, to stabilize the latter to promote the TRIP effect.

The hold in the temperature range 440° C. to 475° C. must be greater than 20 seconds to allow the stabilization of the austenite by enrichment of said austenite with carbon, and less than 120 seconds to limit the area percentage of ferrite and limit to the maximum possible degree the precipitation of carbides. In effect, beyond 120 seconds, cementite Fe₃C precipitates and consequently reduces the amount of carbon available for the TRIP effect starting with the residual austenite. The result is both low mechanical strength on account of an austenite which decomposes and contains less carbon, and low elongation on account of a TRIP effect with an austenite which is less stable because it is less rich in carbon. This austenite will exhibit islands that will be prematurely transformed into martensite when exposed to a mechanical stress. Because martensite is not very ductile, the total elongation of the steel will be reduced.

Preferably, the hold time t_{eg} at the temperature T_{eg} will be between 30 and 80 seconds. Ideally, the hold time will be between 30 and 60 seconds to have an optimal effect on the microstructure and the mechanical properties.

The hot-dip galvanizing is then performed by immersion in a bath of zinc or zinc alloy, the temperature T_{Zn} of which can be between 440 and 475° C.

For example, the composition of the zinc or Zn alloy bath can be such that: Al (%)+Fe (%)+10 (Pb+Cd)<0.55%, with the remainder to make up 100% consisting of Zn.

The galvanized product is then cooled to the ambient temperature at a rate V_{ref2} which is greater than 2° C./s. In this manner, a cold-rolled, annealed and galvanized steel sheet is obtained which contains in area percentage 65 to 85% ferrite and 15 to 35% islands of martensite and residual austenite, it being understood that the residual austenite content is between 10 and 25%.

To promote the phenomenon of internal oxidation of easily oxidized elements such as manganese, aluminum and silicon and thereby facilitate the deposition of the base coat of zinc on the sheet, the annealing in the furnace after the cold rolling is performed at a high dew point, i.e. with an increase of the flow of oxygen into the metal.

When the annealing is performed in an atmosphere having a dew point of −40° C. or less, the product exhibits a prohibitive wettability and the zinc deposited does not cover one hundred percent of the surface of the sheet. Moreover, a poor adherence of the zinc based coating has been found when this dew point is at −40° C.

On the other hand, with a dew point between −20° C. and −15° C., the wettability and the adherence of the zinc based coating will be improved significantly.

Electro-galvanization or PVD (for “Physical Vapor Deposition”) methods can also be used.

This invention will be illustrated below on the basis of the following non-limiting examples:

Steels have been prepared, the composition of which is presented in the following table, expressed in percent by weight. Because the steels IX1, IX2, IX3 and IX4 were used for the fabrication of the sheet claimed by the invention, for purposes of comparison the composition of the steels R1 to R6 which were used for the fabrication of reference sheets is also presented.

TABLE 1
Compositions of steels (% by weight) Rᵢ = References No. i

| | C | Mn | Si | Al | Si + Al | B | P | S | Nb | Ti | Cu | | Ni | | N |
|---|---|---|---|---|---|---|---|---|---|---|---|---|---|---|---|
| Steel | (%) | (%) | (%) | (%) | (%) | (%) | (%) | (%) | (%) | (%) | (%) | Cr (%) | (%) | Mo (%) | (%) |
| IX1 | 0.215 | 1.670 | 0.805 | 0.695 | 1.500 | 0.0004 | 0.0086 | 0.0018 | 0.0006 | 0.0051 | 0.020 | 0.038 | 0.0174 | 0.0020 | 0.0045 |
| IX2 | 0.170 | 1.750 | 0.775 | 0.605 | 1.380 | 0.0002 | 0.023 | 0.0024 | 0.001 | 0.002 | 0.006 | 0.012 | 0.020 | 0.015 | 0.0007 |
| IX3 | 0.205 | 1.780 | 0.775 | 0.705 | 1.480 | 0.0003 | 0.025 | 0.0023 | 0.001 | 0.002 | 0.005 | 0.012 | 0.016 | 0.003 | 0.0007 |
| IX4 | 0.170 | 1.622 | 0.727 | 0.840 | 1.567 | 0.0002 | 0.018 | 0.0021 | 0.030 | 0.0045 | 0.024 | 0.025 | 0.021 | 0.002 | 0.0004 |
| R1 | 0.175 | 1.615 | 0.326 | 1.225 | 1.551 | 0.00035 | 0.08 | 0.0020 | 0.0003 | 0.0120 | 0.017 | 0.020 | 0.021 | 0.0019 | 0.0042 |
| R2 | 0.200 | 1.647 | 1.599 | 0.035 | 1.634 | 0.0003 | 0.010 | 0.004 | 0.001 | 0.0020 | 0.008 | 0.015 | 0.019 | 0.0020 | 0.0043 |
| R3 | 0.160 | 1.720 | 0.775 | 0.605 | 1.380 | 0.0002 | 0.025 | 0.0021 | 0.003 | 0.002 | 0.006 | 0.012 | 0.018 | 0.015 | 0.0004 |
| R4 | 0.155 | 1.611 | 0.793 | 0.797 | 1.590 | 0.0003 | 0.019 | 0.0011 | 0.001 | 0.012 | 0.001 | 0.003 | 0.001 | 0.001 | 0.00011 |
| R5 | 0.159 | 1.593 | 0.806 | 0.785 | 1.591 | 0.0001 | 0.023 | 0.0015 | 0.003 | 0.044 | 0.001 | 0.009 | 0.001 | 0.009 | 0.0003 |
| R6 | 0.166 | 1.605 | 0.722 | 0.835 | 1.557 | 0.0004 | 0.017 | 0.001 | 0.041 | 0.0045 | 0.024 | 0.025 | 0.020 | 0.005 | 0.0004 |

Underlined values: Not in conformance with the invention.

Cast semi-finished products corresponding to the compositions listed above were cast, reheated to 1230° C., and then hot-rolled in a range where the structure is entirely austenitic. The fabrication conditions of these hot-rolled products (end-of-rolling temperature T_{FL} and coiling temperature T_{bob}) are indicated in Table 2.

TABLE 2
Fabrication conditions of the hot-rolled products

| Steel | T_{FL}(° C.) | Ar3 (° C.) | T_{bob}(° C.) |
|---|---|---|---|
| I X1 | 920 | 713 | 580 |
| I X2 | >920 | 716 | 550 |
| I X3 | >920 | 702 | 550 |
| I X4 | >920 | 726 | 535 |
| R1 | 910 | 726 | 550 |
| R2 | 915 | 715 | 540 |
| R3 | 922 | 721 | 560 |
| R4 | >920 | 774 | 540 |
| R5 | >920 | 690 | 540 |
| R6 | >920 | 687 | 540 |

All the hot-rolled products were then pickled and then cold rolled with a rate of reduction between 30 and 80%. Starting with the same composition, certain steels were subjected to different fabrication conditions.

Table 3 indicates the fabrication conditions of the annealed sheet after cold rolling:

Heat rate Vc

Initial austenite content at the end of the hold (inter-critical) γᵢₙᵢₜ

Annealing temperature Tᵣ

Hold time during annealing tᵣ

Rate of cooling after annealing V_{ref}

Rate of cooling after galvanization V′_{ref}

Equalization temperature T_{eg}

Length of time on the equalization step t_{eg}

The transformation temperatures Ac1 and Ac3 are also presented in Table 3.

The microstructure of the TRIP steels was also determined, with a quantification of the content of residual austenite. The area percentages of the MA islands were quantified after etching with metabisulfite, Klemm or Lepera etchant, followed by an image analysis using Aphelion™ software.

The sheets were all coated with Zn.

The end-of-rolling temperatures have been estimated in certain cases, although they remain between 900 and 1000° C. when it is noted that they are greater than 920° C.

The entry “n.e.” means “not evaluated”.

TABLE 3
Fabrication conditions of cold-rolled and annealed sheets

| | | | | | | | V_{ref} | | | |
|---|---|---|---|---|---|---|---|---|---|---|
| | Steel | Vc | A_{c1}-A_{c3} | Tr | tᵣ | γᵢₙᵢₜ | (° C./ | T_{eg} | t_{eg} | V′ref |
| Test | Composition | (° C./s) | (° C.) | (° C.) | (s) | (%) | s) | (° C.) | (s) | (° C./s) |
| 1 | IX1 | 4 | 729-920 | 815 | 45 | 37 | 35 | 460 | 45 | 5 |
| 2 | IX1 | 4 | 729-920 | 850 | 45 | 62 | 35 | 460 | 45 | 5 |
| 3 | IX1 | 5 | 729-920 | 770 | 45 | 25 | 35 | 460 | 45 | 5 |
| 4 | IX1 | 4.4 | 729-920 | 840 | 55 | 60 | 55.5 | 430 | 180 | 8.7 |
| 5 | IX2 | 4.4 | 727-1059 | 800 | 67 | 30 | 34 | 460 | 43 | 5 |
| 6 | IX2 | 4.4 | 727-1059 | 830 | 67 | 35 | 34 | 460 | 43 | 5 |
| 7 | IX3 | 4.4 | 729-1090 | 800 | 67 | 35 | 34 | 460 | 43 | 5 |
| 8 | IX3 | 4.4 | 729-1090 | 830 | 67 | 40 | 34 | 460 | 43 | 5 |
| 9 | IX4 | 4.4 | 727-1154 | 780 | 67 | 30 | 34 | 460 | 43 | 5 |
| 10 | IX4 | 4.4 | 727-1154 | 820 | 67 | 35 | 34 | 460 | 43 | 5 |
| 11 | IX4 | 4.4 | 727-1154 | 850 | 67 | 40 | 34 | 460 | 43 | 5 |
| 12 | IX4 | 3 | 727-1154 | 800 | 128 | 32 | 21 | 460 | 314 | 6 |
| 13 | R1 | 6 | 729-1115 | 850 | 39 | 40 | 47 | 460 | 33 | 7 |
| 14 | R1 | 6 | 729-1115 | 770 | 39 | 24 | 44 | 460 | 33 | 6 |
| 15 | R2 | 4 | 752-875 | 830 | 46 | 50 to 65 | 32 | 460 | 45 | 4.4 |
| 16 | R2 | 3 | 752-875 | 830 | 118 | 50 to 65 | 37 | 400 | 270 | 87 |
| 17 | R3 | 5.5 | 726-1050 | 830 | 37 | 40 to 55 | 40 | 460 | 36 | 6 |
| 18 | R3 | 4.4 | 726-1050 | 830 | 37 | 40 to 55 | 56 | 420 | 180 | 6 |
| 19 | R4 | 5.5 | 20 | 780 | 729-1149 | 36 | 43 | 460 | 34 | 5.5 |
| 20 | R4 | 5.5 | 25 | 850 | 729-1149 | 36 | 43 | 460 | 34 | 5.5 |
| 21 | R5 | 5.5 | 20 | 780 | 717-1138 | 36 | 43 | 460 | 34 | 5.5 |
| 22 | R5 | 5.5 | 25 | 850 | 717-1138 | 36 | 43 | 460 | 34 | 5.5 |
| 23 | R6 | 5.5 | 20 | 780 | 714-1147 | 36 | 43 | 460 | 34 | 5.5 |
| 24 | R6 | 5.5 | 25 | 850 | 714-1147 | 36 | 43 | 460 | 34 | 5.5 |

Underlined values: not in conformance with the invention

The mechanical tensile properties obtained (limit of elasticity Re, strength Rm, elongation at fracture A) are presented in Table 5 below. These values were obtained using an ISO 20×80 test piece with the dimensions presented in Table 4 and illustrated in FIG. 1. Uniaxial tensile forces were used to obtain these mechanical properties, whereby the force was applied in the direction perpendicular to the direction of cold rolling.

TABLE 4
Dimensions of the tensile test pieces, units expressed in mm
(FIG. 1 illustrates the lengths indicated)

| | | | | | | | Dimensions |
|---|---|---|---|---|---|---|---|
| Type | B | Lo | Lc | R | T | Lt | blank |
| ISO 20 × 80 | 20 | 80 | 100 | 20 | 30 | 260 | 260 × 32 |

Coatability was quantified as follows: a sheet is bent 180° around a wedge, and adhesive tape is then applied to the outside, bent surface; when the adhesive tape is removed, if the coating is adherent it does not come off with the tape. If the coating is not adherent, the coating comes off with the tape.

Likewise, the sensitivity to embrittlement by penetration of liquid Zn is assessed by a welding test on a part coated with Zn. The test consists of observing the cracks and their depth under a microscope, for each material and method used, and a relative classification is then made.

For both these tests, the scores are expressed from 1 (poor coatability/sensitivity to liquid Zn) to 5 (very good coatability/not sensitive to liquid Zn). Results of 1-2 are considered unsatisfactory.

TABLE 5
Results obtained on the cold-rolled and annealed sheet

| Steel | Fraction of | | | | Sensitivity to | Coatability when | Average length of the |
|---|---|---|---|---|---|---|---|
| sheet | (MA %) | Re (MPa) | Rm (MPa) | A (%) | liquid Zn | immersed in liquid Zn | MA islands (μm) |
| 1 | 19 | 444 | 796 | 27 | 3 | 5 | 1.06 |
| 2 | 22 | 445 | 787 | 27 | 3 | 5 | 1.06 |
| 3 | ≦15 | 425 | 735 | 28 | 3 | 5 | n.e |
| 4 | ≦15 | 460 | 730 | 32 | 3 | 5 | n.e |
| 5 | 15 < X < 21 | 376 | 802 | 22 | 4 | 5 | <1.3 |
| 6 | 15 < X < 21 | 380 | 805 | 22 | 4 | 5 | <1.3 |
| 7 | 15 < X < 21 | 389 | 844.5 | 19 | 3 | 5 | 1.04 |
| 8 | 15 < X < 21 | 386 | 829 | 20 | 3 | 5 | 1.04 |
| 9 | 15 < X < 21 | 560 | 889 | 20 | 4 | 5 | <1.1 |
| 10 | 15 < X < 21 | 568 | 860 | 19 | 4 | 5 | <1.1 |
| 11 | 15 < X < 21 | 557 | 861 | 19 | 4 | 5 | <1.1 |
| 12 | 15 < X < 21 | 577 | 857 | 15.3 | 4 | 5 | <1.1 |
| 13 | 15 | 475 | 735 | 27 | 4 | 5 | n.e |
| 14 | 13 | 429 | 684 | 29 | 4 | 5 | n.e |
| 15 | >22 | 437 | 933 | 21.6 | 2 | 2 | 1.6 |
| 16 | 20 | 540 | 820 | 31 | 2 | 2 | 1.74 |
| 17 | ≦15 | 474 | 735 | 24 | 3 | 5 | n.e |
| 18 | ≦15 | 450 | 705 | 25.4 | 3 | 5 | n.e |
| 19 | ≦15 | 411 | 737 | 27 | 4 | 5 | n.e |
| 20 | ≦15 | 426 | 729 | 28 | 4 | 5 | n.e |
| 21 | ≦15 | 700 | 963 | 15 | 4 | 5 | n.e |
| 22 | ≦15 | 640 | 875 | 17 | 4 | 5 | n.e |
| 23 | ≦15 | 555 | 869 | 14 | 4 | 5 | n.e |
| 24 | ≦15 | 557 | 880 | 18 | 4 | 5 | n.e |

Underlined values: not in conformance with the invention

The steel sheets claimed by the invention have a set of microstructural and mechanical characteristics that make possible the advantageous fabrication of parts, in particular for applications as structural parts: strength between 780 and 900 MPa, elongation at fracture greater than 19% with an ISO 20×80 test piece as described by Table 4, good coatability and a relatively low sensitivity to embrittlement by penetration of liquid zinc. FIG. 2 illustrates the morphology of the steel sheet 1 with the MA islands in white.

The sheets IX1, IX2, IX3 and IX4 are as claimed by the invention from the point of view of the chemical composition. The tests associated with these compositions, which are numbered from 1 to 12, make it possible to demonstrate the stability of the properties obtained and to demonstrate the limits of the fabrication method to obtain the sheet claimed by the invention.

The chemical compositions IX1, IX2, IX3 and IX4 associated with the tests claimed by the invention (1, 2 and 5 to 11 inclusive) are relatively insensitive to the penetration of liquid zinc, in particular during resistance spot welding. These compositions have a good coatability and MA islands which surprisingly have an average [length] of 1.06 micrometers, i.e. fine grains. Their mechanical strength is also between 780 and 900 MPa and their total elongation is significantly greater than 19%. FIG. 2 illustrates the microstructure of the sheet from test 1. Each island of martensite/austenite, also called an “MA island”, is characterized by its maximum length and its maximum width. On the basis of a representative sample of more than 100 characterized islands, the average length of the islands is surprisingly low and equal to 1.06 micrometers. The confidence interval is 95%, which gives an average of between 0.97 and 1.15 micrometers. The smallest island was measured at 0.38 micrometers and the longest at 3.32 micrometers. The first quartile, i.e. the largest island of the 25% of the smallest islands, was measured at 0.72 micrometers; the third quartile, i.e. the smallest of the 25% of the longest islands, was measured at 1.29 micrometers. The median was calculated at 0.94 micrometers. The proximity between the median and the average is a good indicator that the data exhibit a distribution centered on a length of 1 micrometer to within 0.1 μm. The MA islands are also characterized by their shape factor, i.e. the ratio between their length and their maximum width

$$\frac{{L}_{ma x}}{{L}_{m i n}} .$$

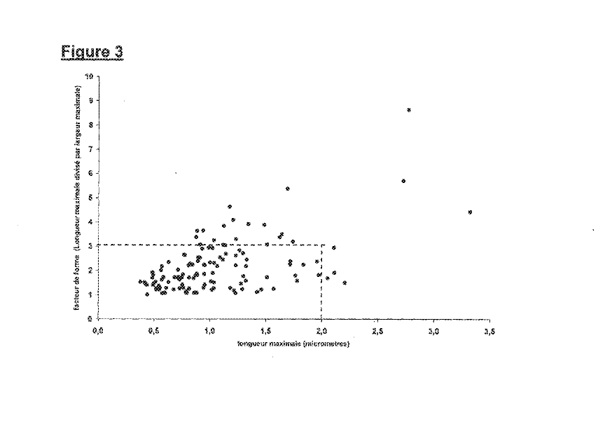

The MA islands in test 1 have a shape factor distribution represented by FIG. 3. The average of the shape factors is 2.15. The confidence interval is 95%, which gives an average shape factor of between 1.95 and 2.34.

Test 3 associated with the chemical composition IX1 has an austenite content at the end of the hold time γᵢₙᵢₜ which is too low, because the hold temperature is below Ac1+50° C., and consequently the final area percentage of MA is too low and this microstructural characteristic is associated with a reduction of the mechanical strength in the framework of the invention. Test 4 associated with chemical composition IX1 has undergone an annealing at a temperature that makes it possible to obtain 60% γᵢₙᵢₜ and is therefore within the interval claimed by the invention. However, the equalization temperature T_{eg} is 430° C., and is therefore too low, and the equalization temperature time t_{eg} is 180 seconds, which is too long. Therefore the area percentage of these islands is too low, and the consequence is a mechanical strength which is less than 780 MPa.

Test 12, which is associated with the chemical composition IX4, has undergone an equalization step t_{eg} of 314 seconds, which is above the specification in the framework of the invention which is 120 seconds, and the total elongation is too low at 15.3%.

R1 has a chemical composition which is outside the targets specified by the invention. R1 has a Si content which is too low and phosphorus content which is too high. Therefore tests 13 and 14 have mechanical strength properties which are unsatisfactory in relation to the targets specified by the invention because they are below 780 Mpa, in spite of complying with the fabrication conditions for test 13. Test 14 also has an annealing temperature Tᵣ which is less than Ac1+50° C.

The chemical compositions R3 and R4 are not in conformance with the invention because the mass concentrations of carbon are less than 0.17%. Tests 17, 18, 19 and 20 associated with R3 (17 and 18) and R4 (19 and 20) do not make it possible to achieve 780 MPa. The fractions of MA islands obtained at the end of this annealing are too low, because there is not enough carbon to stabilize the austenite and form sufficient MA islands. The content of these MA islands is therefore too low and consequently the mechanical strength is less than 780 MPa for these tests.

The chemical composition R2 is not in conformance with the invention because the Si content is greater than 1% and the aluminum content is less than 0.5%. Two tests originated from this chemical composition, tests 15 and 16. Test 15 does not correspond to the invention, in spite of an annealing cycle that does correspond to the claim. The fraction of MA islands at the end of this annealing is too high on account of the dual hardening effect of silicon and its ferrite-forming capacity, which is less than that of aluminum. In fact, ferrite is a soft structure compared to the MA islands and the utilization of the ferrite-forming elements softens the steel sheet; in this case, aluminum would have served to re-balance the hardnesses to obtain a sheet with a mechanical strength of less than 900 MPa. Therefore the mechanical strength of the steel sheet 15 is greater than 900 MPa and the average size of the MA islands is significantly greater than 1.3 micrometers. This grain size will facilitate the connectivity between the grains and accelerate the propagation of a crack already formed. In addition, the sensitivity to the penetration of liquid zinc (2/5) of this reference is less than the minimum specified for the invention (3/5).

Test 16 does not correspond to the invention; the average size of the MA islands is significantly greater than 1.3 micrometers. The silicon content will also lead to the formation of silicon oxides on the surface during the annealing prior to the hot-dip galvanizing. The coatability of this product will therefore be less than the specified minimum score of 3 out of 5. Its sensitivity to the penetration of liquid zinc is also less than 3 out of 5.

The chemical composition R5 does not correspond to the invention. The carbon content is less than 0.17% and the Ti content is greater than 0.020% As shown by tests 21 and 22, the result is a failure to achieve the specified elongation of 19%.

The chemical composition R6 does not correspond to the invention because the niobium content is greater than 0.030%. Examples 23 and 24 show that the specified elongation of 19% is not achieved.

The steel sheets claimed by the invention will advantageously be used for the fabrication of structural or safety parts in ground motor vehicles. The following non-restrictive examples can be cited: crossbeams, rails, center pillar.

What is claimed is:

1-17. (canceled)

18. A cold-rolled steel sheet coated with zinc or zinc alloy, the composition of which includes the following, expressed by weight:
0.17%≦C≦0.25%
1.5%≦Mn≦2.0%
0.50%≦Si≦1%
0.50%≦Al≦1.2%
B≦0.001%
P≦0.030%
S≦0.01%
Nb≦0.030%
Ti≦0.020%
V≦0.015%
Cu≦0.1%
Cr≦0.150%
Ni≦0.1%
0%≦Mo≦0.150%
whereby Si+Al≧1.30%,
the remainder of the composition consists of iron and the inevitable impurities resulting from processing,
a microstructure of the composition includes, with the contents expressed in area percentage:
of 65 to 85% ferrite, and
of 15 to 35% islands of martensite and residual austenite, the ferrite containing less than 5% non-recrystallized ferrite, a total content of residual austenite being between 10 and 25% and a total martensite content being less than or equal to 10%, an average size of the martensite and residual austenite islands being less than 1.3 micrometers, and an average shape factor of the islands being less than 3,
a mechanical strength Rm of the sheet being between 780 and 900 MPa, and an elongation at fracture A % being greater than or equal to 19%.

19. The steel sheet as recited in claim 18, wherein the composition includes the following, expressed by weight,
0.19%≦C≦0.23%.

20. The steel sheet as recited in claim 18, wherein the composition includes the following, expressed by weight,
1.6%≦Mn≦1.8%.

21. The steel sheet as recited in claim 18, wherein the composition includes the following, expressed by weight,
0.7%≦Si≦0.9. %

22. The steel sheet as recited in claim 18, wherein the composition includes the following, expressed by weight,
0.6%≦Al≦0.8%.

23. The steel sheet as recited in claim 18, wherein the composition includes the following, expressed by weight,
0%<B≦0.0005%.

24. The steel sheet as recited in claim 18, wherein more than 90% in area percentage of the martensite and residual austenite islands have a size less than or equal to two micrometers.

25. A method for the fabrication of a steel sheet cold rolled and coated with zinc or zinc alloy, comprising the following steps:
procuring a steel having the composition recited in claim 18;
casting the steel in a form of a semi-finished product;
heating the semi-finished product to a temperature between 1150 and 1250° C.;
hot rolling the semi-finished product, finishing the rolling at an end-of-rolling temperature T_{FL} greater than or equal to Ar3 to obtain a sheet;
coiling the hot rolled sheet at a temperature T_{bob} between 500 and 600° C.;
cooling the hot rolled sheet to an ambient temperature;
cold rolling the sheet;
reheating the cold-rolled sheet at a rate V_{c} between 1 and 30° C./s to a temperature Tᵣ for a length of time tᵣ which is greater than or equal to 15 seconds, the temperatures and times being selected to obtain an area percentage of between 35 and 70% austenite;
cooling the cold-rolled sheet to a temperature T_{eg} between 475 and 440° C. at a rate V_{ref} which is sufficiently rapid to prevent a formation of pearlite;
holding the cold-rolled sheet at the equalization temperature T_{eg} for a length of time t_{eg} between 20 and 120 seconds;
coating the cold-rolled sheet by continuous hot-dipping in a bath of zinc or zinc alloy;
cooling the cold-rolled, coated sheet to the ambient temperature.

26. The method for the fabrication of the sheet as recited in claim 25, wherein the temperature T_{FL} is greater than 900° C.

27. The method for the fabrication of the sheet as recited in claim 25, wherein the temperature T_{FL} is greater than 920° C.

28. The method for the fabrication of the sheet as recited in claim 25, wherein a dew point during the annealing at the temperature Tᵣ for the time tᵣ is between −20° C. and −15° C.

29. The method for the fabrication of the steel sheet as recited in claim 25, wherein the temperature Tᵣ is between Ac1+50° C. and Ac3−50° C.

30. The method for the fabrication of the steel sheet as recited in claim 25, wherein the temperature Tr is between Ac1+50° C. and Ac1+170° C.

31. The method for the fabrication of the steel sheet as recited in claim 25, wherein the time t_{eg} is between 30 and 80 seconds.

32. The method for the fabrication of the steel sheet as recited in claim 25, for which said time t_{eg} is between 30 and 60 seconds.

33. A method for the fabrication of a part comprising:
welding of at least one sheet cold rolled and coated as recited in claim 18 by resistance spot welding.

34. A method for the fabrication of a part comprising:
welding of at least one sheet obtained by the method recited in claim 25 by resistance spot welding.

35. A structural or safety part for ground motor vehicles comprising:
a steel sheet cold rolled and coated as recited in claim 18.

36. A method for the fabrication of structural or safety parts for ground motor vehicles comprising:
obtaining the steel sheet cold rolled and coated as recited in claim 25.

37. The method for the fabrication of the steel sheet as recited in claim 25, further comprising pickling the hot rolled sheet.

38. The method for the fabrication of the steel sheet as recited in claim 25, wherein the steps are performed successively.
